(19) United States
(12) Patent Application Publication
(10) Pub. No.: US 2002/0043516 A1
(43) Pub. Date: Apr. 18, 2002

(54) Vacuum switch and vacuum switchgear using the same

(75) Inventors: Ayumu Morita, Hitachi (JP); Masashige Tsuji, Hitachi (JP); Toru Tanimizu, Hitachi (JP); Satoru Kajiwara, Hitachi (JP); Katsuhiro Komuro, Hitachi (JP)

Correspondence Address: MATTINGLY, STANGER & MALUR, P.C., 1800 Diagonal Road, Suite 370, Alexandria, VA, 22314, US

(73) Assignee: Hitachi, Ltd.

(21) Appl. No.: 10/022,429

(22) Filed: Dec. 20, 2001

Related U.S. Application Data
(62) Division of application No. 09/463,573, filed on Jan. 28, 2000.

(30) Foreign Application Priority Data
Oct. 2, 1998 (JP) 10-280667
Sep. 22, 1999 (JP) PCT/JP99/05187

(51) Int. Cl. H01H 33/66

(52) U.S. Cl. 218/118

(57) ABSTRACT

An object of the present invention is to provide a vacuum switch which secures safety of a worker at performing maintenance and inspection and is high in reliability, and to provide a vacuum switchgear using the vacuum switch.

The above object can be attained by a vacuum switch and a vacuum switchgear in which a pair of detachable electrodes are disposed in a grounded vacuum container, and an insulation coating is applied onto an inner surface of the vacuum container.

### FIELD OF THE INVENTION

The present invention relates to a vacuum switch and a vacuum switchgear using the vacuum switch and, more particularly a vacuum switch having an electric conductive vacuum container and a vacuum switchgear using the vacuum switch.

### BACKGROUND OF THE INVENTION

In regard to increasing demand of power consumption in a congested urban district, there are problems such as difficulty of obtaining a site for a distribution substation, lack of installation room for wire ducts, and requirement for a high operability of a supply facility. In order to solve these problems, it is necessary that the voltage is increased, that is, that load is actively absorbed in a voltage system having a large capacity per line. Increase in distribution voltage relates to forming of an effective electric power supply system. Therefore, it is necessary to make the distribution components and the distribution and transformation facility further compact.

As for the distribution and transformation components to be made compact, there is an SF₆ gas insulation switchgear disclosed in, for example, Japanese Patent Application Laid-Open No. 3-273804. The switchgear is formed by that a breaker, two isolators and a grounding device individually fabricated are contained in a unit chamber and a bus chamber of power distribution containers filled with an insulation gas. In a case where a vacuum breaker is used as a breaker, making and breaking of a circuit is performed by vertically moving a movable electrode against a fixed electrode using an actuator of the vacuum breaker, or making and breaking of a circuit is performed by vertically or horizontally rotating a movable electrode around an axis as a fulcrum to come into contact with a fixed electrode, as described in Japanese Patent Application Laid-Open No. 55-143727.

The distribution and transformation facility having a gas insulation switchgear receives electric power transmitted from, for example, an electric power company using a gas insulation breaker and the like, transforms the electric power to a voltage appropriate for loads, and the electric power is supplied to the loads, for example, a motor or the like. When maintenance and inspection of the distribution and transformation facility are performed, after a gas insulation breaker is switched off, an isolator provided separately from the gas insulation breaker is opened. Then, residual charge and induced current are to let to flow to the ground by grounding a grounding device and re-application from the power supply is prevented to secure safety of workers. Further, since an accident will occur when the grounding device is grounded while the bus is charged, an interlock is provided between the breaker and the grounding device.

Since SF₆ gas used in an insulation switchgear as an insulation gas produces an ill effect of global warming, a used amount of SF₆ gas is being globally reduced. Therefore, a switchgear not using SF₆ gas is required, and methods of actively using a vacuum as an insulation medium are being developed. There is a vacuum bulb as a switching device using a vacuum as an insulation medium. Because a vacuum container in a conventional vacuum bulb is formed by interposing both ends of an insulator cylinder for insulating between electrodes or a metallic container in a floating electric potential between insulation cylinders, there is a problem that a worker can not directly touch the vacuum bulb. Because the metallic container in a floating electric potential is charged even when current is not conducted, the worker can not touch the vacuum bulb unless it is successively grounded using a grounding rod or the like.

An object of the present invention is to provide a high-reliable vacuum switch which can secure safety of a worker during maintenance and inspection by using a grounded metallic vacuum container, and is equipped with a means for avoiding ions or electrons emitted from an arc at breaking flowing into the metallic container in the grounding electric potential, and to provide a vacuum switchgear using the vacuum switch. Since an amount of current flowing into the grounded metallic object increases in proportional to a surface area of the vacuum container, this measures becomes inevitable when the vacuum container becomes large as the capacity is increased.

### SUMMARY OF THE INVENTION

The present invention relates to a vacuum switch using a grounded vacuum container and a vacuum switchgear using the vacuum switch. In more detail, the present invention provides a vacuum switch characterized by that an insulation is coated onto an inner surface of a grounded vacuum container having a pair of detachable electrodes inside the vacuum container, and a vacuum switchgear using the vacuum switch.

In the present invention, the grounded vacuum container means a vacuum container which is grounded so that a worker can safely touch the vacuum container during maintenance and inspection of the switch or the switchgear in accordance with the present invention. Therefore, it is necessary to form most part of the vacuum container of an electric conductive material or a material having an electric conductive coating.

In the present invention, it is possible to prevent ions or electrons emitted from an arc at breaking from flowing from the vacuum container to the ground by applying an insulation onto the inner surface of the vacuum container. In the present invention, it is preferable that the insulation is a ceramic, and Al₂O₃ or ZrO₂ is used as the ceramic. The insulation may be coated, melt-sprayed, applied or stuck. Further, the insulation is not necessary to cover all over the surface, and may be applied onto an inner surface of the vacuum container near an opening portion of an arc shield. An example of film forming using plasma melt-spray will be described as an embodiment of the present invention. The plasma melt-spray is performed by melting ceramic at a high temperature higher than 2000° C., and spraying the melted ceramic onto the inner surface of the vacuum container to form a film. As the pre-treatment, the inner surface is sandblasted to be roughened. The thickness of the film is thicker than 0.1 mm, and preferably within a range of 0.1 to 2.0 mm. Although it is preferable that the film is thick, there is a problem in that cracks may be produced in the film by repetition of flowing and stopping of current when the thickness is too thick. An ion beam irradiation method may be used for the film forming instead of the plasma melt-spray method.

In the present specification, the switch means a machine which performs making and breaking between the fixed electrode and the movable electrode. The switchgear means a machine including a control gear which contains a combination of one or more switching units, one or more units among a operating, a measurement, a protecting and an adjusting units, and internal connections in an enclosed box.

Further, in the present invention, the vacuum degree is below 10⁻⁴ torr, and it is preferably lower than 10⁻⁶ torr and particularly lower than 10⁻⁸ torr.

### BRIEF DESCRIPTION OF DRAWINGS

FIG. 1 is a vertical cross-sectional view showing an embodiment of a vacuum switchgear in accordance with the present invention.

FIG. 2 is a vertical cross-sectional view showing another embodiment of a vacuum switchgear in accordance with the present invention.

FIG. 3 is a vertical cross-sectional view showing another embodiment of a vacuum switchgear in accordance with the present invention.

FIG. 4 is a vertical cross-sectional view showing a further embodiment of a vacuum switchgear in accordance with the present invention.

FIG. 5 is a front view of the vacuum switchgear of FIG. 1, and shows a state of opening a lower door.

FIG. 6 is a circuit diagram explaining operation of the vacuum switch of FIG. 4.

FIG. 7 is a cross-sectional side view showing the main portion of a vacuum switch used in the present invention, and shows a grounding state of the movable electrode.

FIG. 8 is a cross-sectional side view showing the main portion of the vacuum switch used in the present invention, and shows a switching-on state of the movable electrode.

FIG. 9 is a perspective view showing another embodiment of a vacuum switch in accordance with the present invention.

FIG. 10 is a longitudinal sectional view showing another embodiment of the vacuum switch in accordance with the present invention.

FIG. 11 is a sectional side view showing another embodiment of the vacuum switch in accordance with the present invention.

### DESCRIPTION OF THE PREFERRED EMBODIMENTS

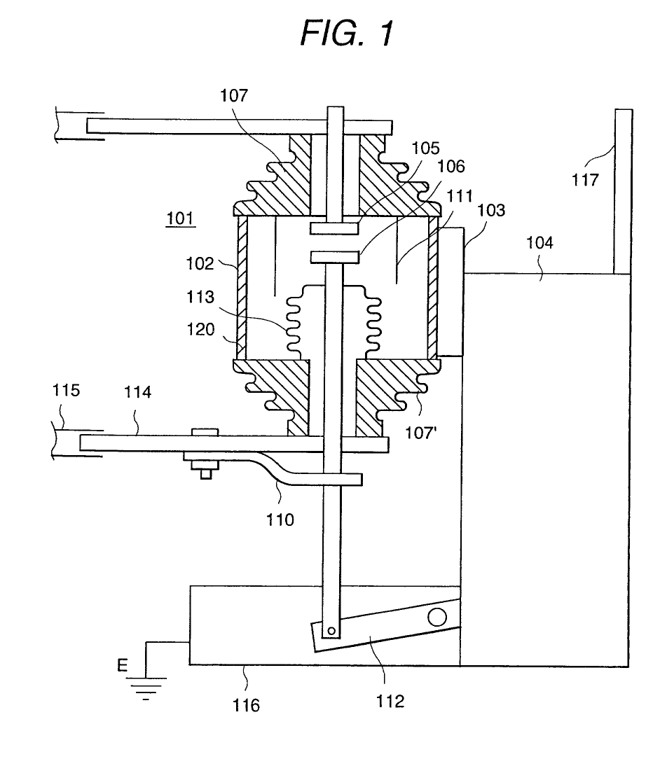

FIG. 1 shows the basic structure of an embodiment of a vacuum switchgear in accordance with the present invention. A cylindrical side wall 102 of a vacuum container 101 is made of an electric conductive material, for example, stainless steel. By fixing the cylindrical side wall 102 to an operation compartment 104 through an electric conductive mounting base 103 attached onto the cylindrical side wall, the cylindrical side wall 102 is grounded E through the electric conductive operation compartment 104 and a support portion 116. A protective plate 117 for protecting a vacuum switch is disposed above the operation compartment 104. Further, wheels, not shown, are provided in the bottom portions of the operation compartment 104 and the support portion 116 so that the operation compartment 104 and the support portion 116 may be moved.

Insulators 107 and 107′ are provided in the upper portion and the lower portion of the vacuum container 101, and a fixed electrode 105 and a movable electrode 106 are arranged through the insulators 107 and 107′, respectively. The movable electrode 106 is supported by the insulator 107′ through a bellows 113. The movable electrode 106 may be vertically moved by an operating rod 112. Further, the movable electrode 106 is electrically connected to an external circuit 115 through a flexible conductor 110 and a flexible conductor 114. An arc shield 111 is arranged near the fixed electrode 105 and movable electrode 106 to prevent a ground fault which is caused by touching of an arc produced at breaking to the vacuum container. The cylindrical side wall 102 is coated with an insulator 120. The insulator is preferably made of a ceramic, and particularly Al₂O₃ or ZrO₂ is preferable. In the present invention, the film is formed through the plasma melt-spray method. Ceramic is melted at a high temperature higher than 2000° C., and the melted ceramic is sprayed onto the inner surface of the vacuum container to form a film. The inner surface is sandblasted to be roughened as the pre-treatment, and then the melt-spraying is performed. The thickness of the film is thicker than 0.1 mm, and preferably within a range of 0.1 to 0.2 mm. When the thickness of the film is thin, the insulating performance is insufficient. Although it is preferable that the film is thick, there is a problem in that cracks may be produced in the film by repetition of flowing and stopping of current when the thickness is too thick. An ion beam irradiation method may be used for the film forming instead of the plasma melt-spray method. The fixed electrode 105 and the movable electrode 106 are gas-tightly sealed inside the vacuum container 101. By containing the electrodes in the grounded vacuum container, insulating distances to the other component such as an operating mechanism can be shortened.

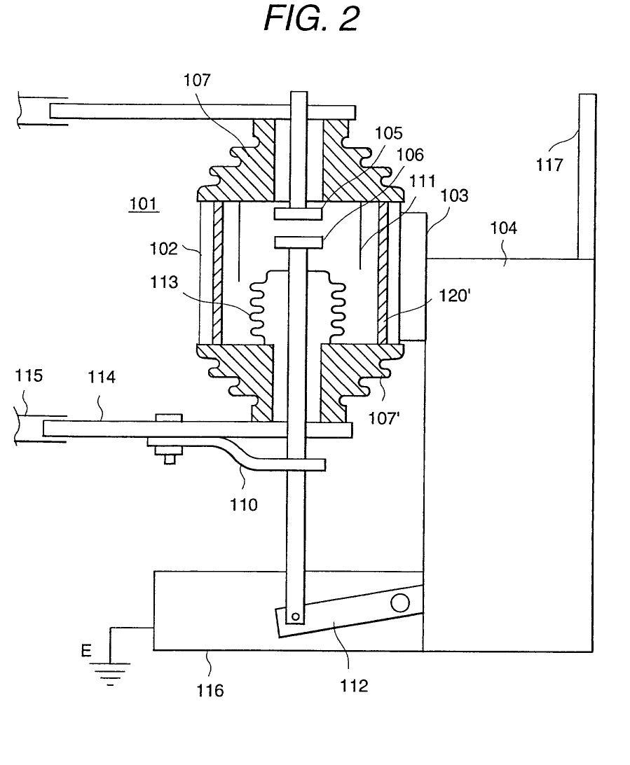

FIG. 2 shows the basic structure of another embodiment of a vacuum switchgear in accordance with the present invention.

The structure of FIG. 2 is that a ceramic cylinder 120′ is disposed inside the cylindrical side wall 102 instead of melt-spraying ceramic 120 onto the inner surface of the cylindrical side wall 102 of the vacuum container 101 in FIG. 1. The present embodiment can attain the same effect as that of FIG. 1.

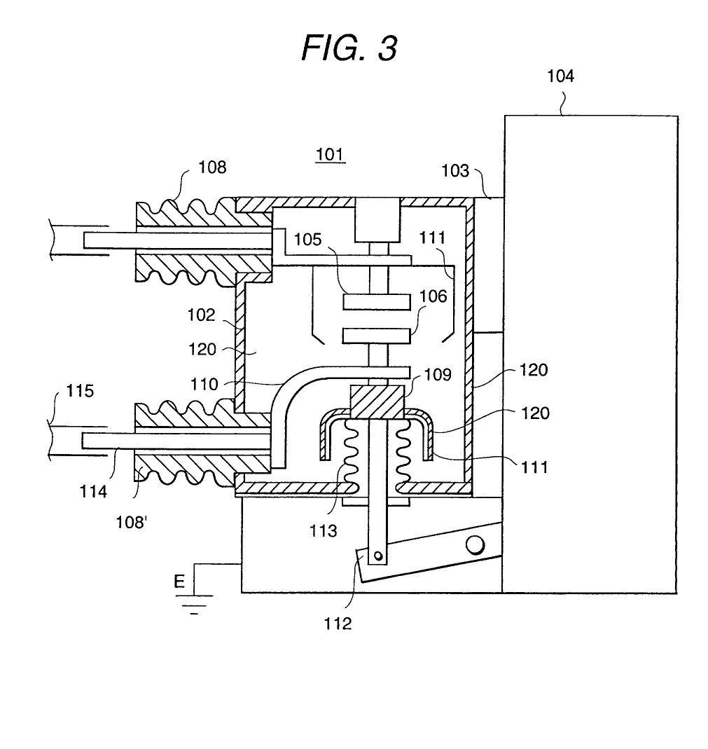

FIG. 3 shows the basic structure of a further embodiment of a vacuum switchgear in accordance with the present invention. In this embodiment, insulators 108, 108′ are attached to the cylindrical side wall 102 of the vacuum container 101. Further, a flexible conductor 110 and a bellows 113 are disposed inside the vacuum container 101. The movable electrode 106 and the bellows 113 are insulated by an insulator 109. An arc shield 111 is attached to the insulator 109. An insulation 120 is coated onto the arc shield 111 and the cylindrical side wall 102. The insulation is preferably a ceramic, and particularly Al₂O₃ or ZrO₂ is preferable. Furthermore, the insulators 108, 108′ are arranged in the side of the container.

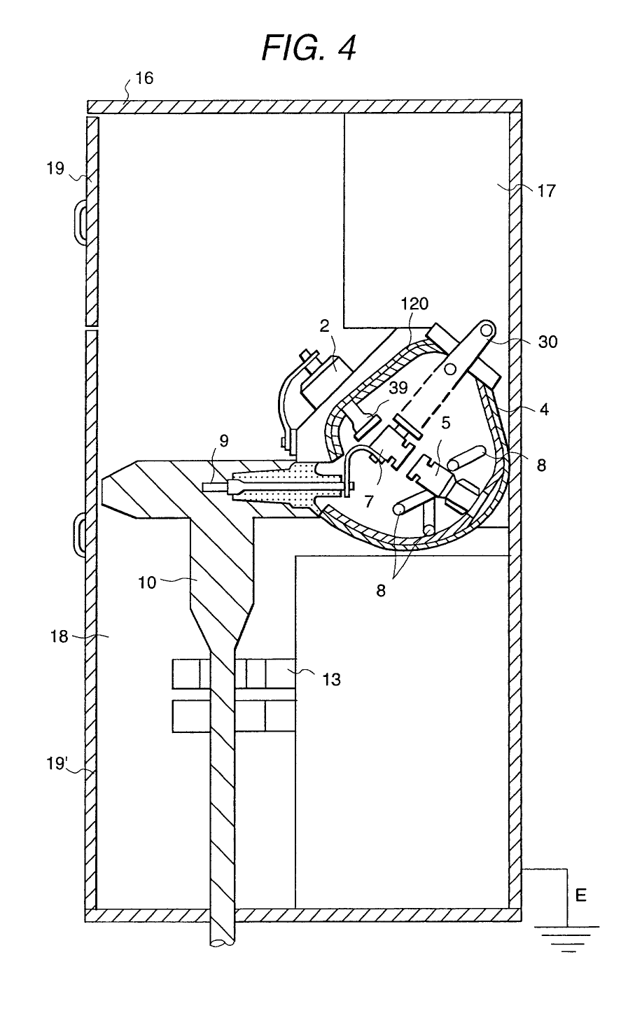

As shown in FIG. 4, the switchgear comprises a vacuum container 4 containing a fixed electrode 5, a movable electrode 7 and a load conductor 9; an operation compartment 17 having an operating mechanism portion for operating a movable blade 30 and the movable electrode 7; a conductor compartment 18 containing the load side conductor 9 and a cable head 10 and so on; and a metallic cubicle 16 for containing them.

The grounded vacuum container 4 is made of, for example, stainless steel members, and the cross-sectional shape is preferably a spherical surface or a curvilinear surface. The inner surface is applied with an insulation coating 120. Thereby, the mechanical strength of the vacuum container 4 can be increased, and the thickness of the vacuum container can be thinned and the weight of the vacuum container is lightened. The vacuum switch 1 is contained in the cubicle 16. The cubicle 16 has the operation compartment 17 and the conductor compartment 18 in the upper side and the lower side of the vacuum switch 1, respectively. The operating compartment 17 is arranged above the vacuum switch 1, and an openable door 19 is attached in the front side. The conductor compartment 18 is arranged in the lower left side of the vacuum container 4.

The operation compartment 17 and the cable head 10 are diagonally arranged through the vacuum container 4. The operation compartment 17 contains the operating mechanism portion for rotating the movable blade 30 and the movable electrode 7. Since tools for maintaining and inspecting the operation compartment can be put on the vacuum container 4 of the operation compartment 17, maintenance and inspection can be easily performed.

The switchgear is a machine unifying a breaking function, an isolating function, a grounding function and bus in a unit. That is, the switchgear is mainly composed of the fixed electrode 5, the grounding electrode 6 of the grounding device 2 and the movable electrode 7 movable between them. The fixed electrode 5 is connected to an inner bus 8. There are three inner buses 8 for three phases of UVW, and each of the inner buses 8 is connected to a bus for each corresponding phase. The movable electrode 7 is connected to the load side conductor 9, and the load side conductor 9 is connected to the cable head 10 extending outside the vacuum container. Further, the movable electrode 7 is mechanically connected to the movable blade 30 to be described later. The movable electrode 7 is rotated in the vertical direction or the horizontal direction by movement of the movable blade 30 driven by the operating mechanism portion contained in the operation compartment 17.

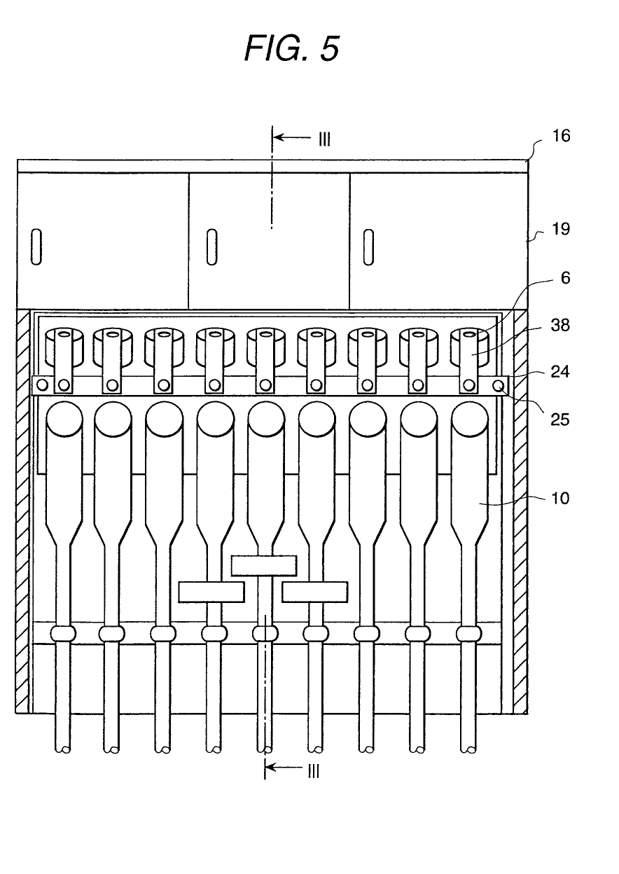

FIG. 5 is a front view of the switchgear of FIG. 4, the grounding conductors 6 of the grounding devicees in the openable door 19 are connected to a common grounding conductor 24 through the flexible conductors 38. Both ends of the common grounding conductor 24 are fixed to a switchboard 16. The switchgear of FIG. 5 is composed of three circuit switchgears, and three vacuum switches for UVW phases are arranged for each of the circuit switchgears. Therefore, the switchgear of FIG. 4 is composed of nine vacuum switches in total. The cable head 10 is connected to the load side conductor 9, not shown in the figure. A current transformer 13 is provided to the cable head 10 for each phase of the second circuit switchgear. The current transformers 13 are provided to the other of the first and the third circuit switchgears, if necessary.

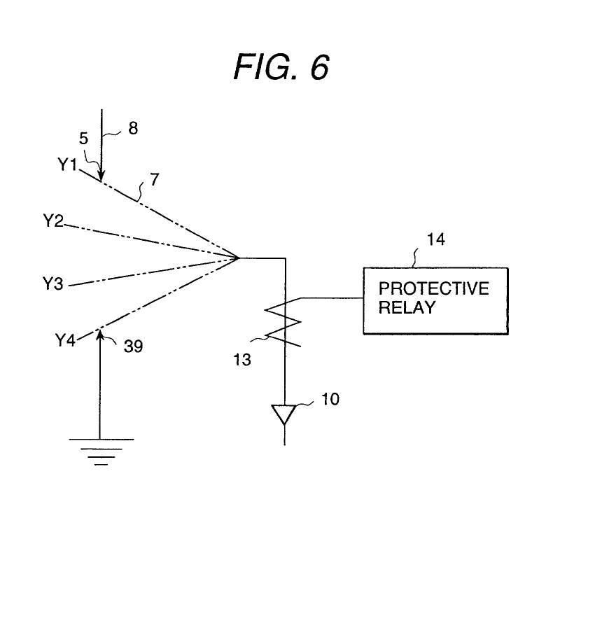

Operation of the switchgear of the present invention will be described below, referring to FIG. 6. The movable electrode 7 stops at the four positions of FIG. 6 as it is moved from the fixed electrode 5 to the grounding electrode 39. Current is conducted at the turning-on position Y1 where the movable electrode 7 is in contact with the fixed electrode 5. As the movable blade 30 is driven by the operating mechanism, the movable electrode 7 is rotated in the lower side than the turning-on position Y1 as shown in the figure and is detached from the fixed electrode 5 to break current and stop at the position Y2. At the breaking position Y2, the movable electrode 7 is stopped at this position until an arc generated at breaking of the contact point is extinguished. After perfect completion of breaking, an operator separately operates to move the movable electrode 7 to the isolating position at performing inspection. The stopping time is a time equivalent to one cycle from generation of the arc to distinguishing the arc. Further, the movable electrode 7 is rotated in the lower side, and is detached from the fixed electrode 5 to keep an insulation distance apart enough not to produce an electric breakdown by thunder and not to cause an electric shock in a worker in the load conductor side, and stopped at the isolating position Y3.

In a state that the movable electrode is stopped at the position Y2 or Y3, the movable contact point is rotated to the position Y2 or to the grounding position Y4 by a driving force of the driving mechanism. The movable electrode 7 is further rotated in the lower side, and is brought in contact with the grounding electrode 39 at the grounding position Y4. Then, by giving a command to the driving mechanism, the movable electrode 7 is again positioned at the position Y3, Y2 or Y1. The movable electrode may be moved from the breaking position Y2 to the grounding position Y4 by eliminating the isolating position Y3.

The movable electrode 7 can position the four positions with once of the rotating operation while the movable electrode 7 is rotated from the fixed electrode 5 to the grounding electrode 39 in a vacuum of high insulation. Two or more functions (breaking, isolating, grounding) can be given to the one vacuum switch. As a result, although the conventional switchgear needs to have plural components corresponding to individual the functions, the plurality of functions can be performed by the one vacuum switch, and accordingly number of components can be reduced.

Since the movable electrode 7, the fixed electrode 5 and the grounding electrode 39 are put together in a position, the vacuum switch can be made smaller in size compared to the conventional technology. In the case where the isolating position Y3 is provided in a different power supply butting system, for example, in a two-line power receiving system having two electric power line systems, when a phase switchgear in one of the line systems is in operation at the turning-on position Y1 and a phase switchgear in the other of the line systems is on standby at the isolating position Y3, it is safe if a worker touches the load side conductor 9. Further, since the operation can be continuously performed in switching from standby to operation or from operation to standby, the operation is fast in speed and easy in operation. Furthermore, there is no need to equipped with a mechanism for preventing an erroneous operation called as an interlock.

Further, it is also possible to cope with an accident in the power line system by detecting conduction current using the current transformer 13, and operating the protective relay 14 to trip the operating mechanism portion, not shown.

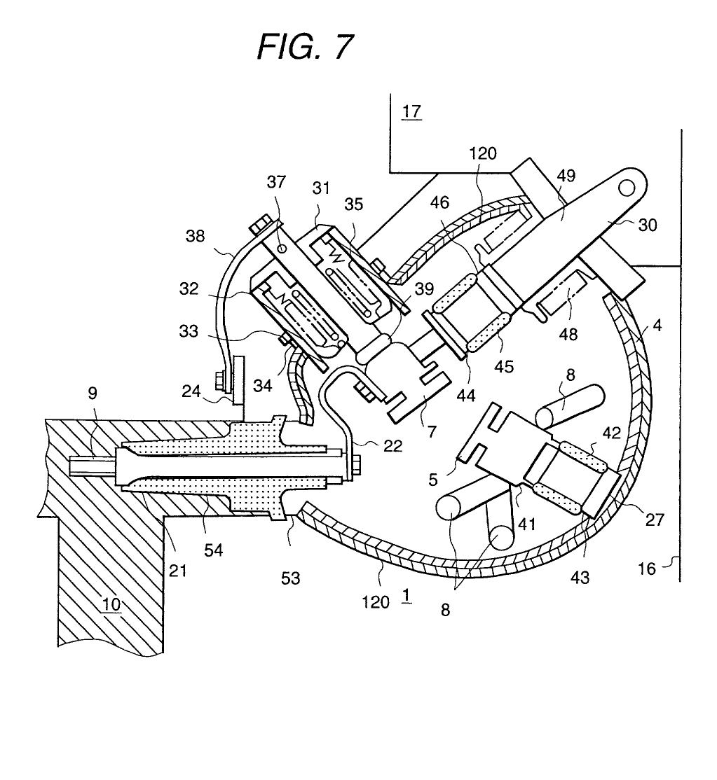

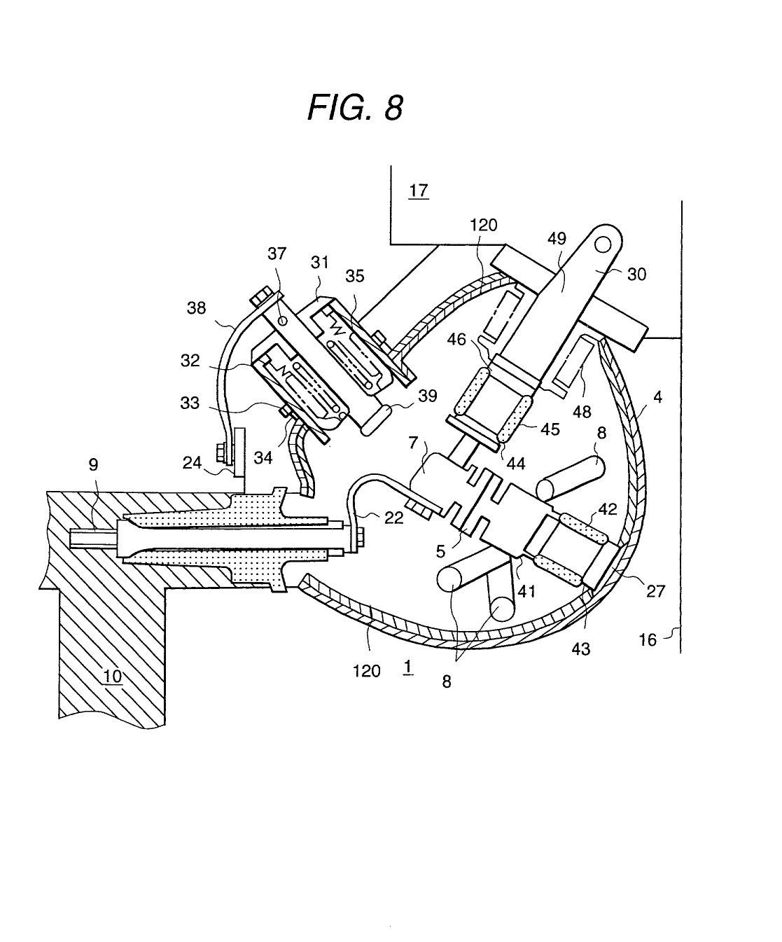

The structure and the operation of an embodiment of a switchgear in accordance with the present invention will be described below, referring to FIG. 7 and FIG. 8. The moveble electrode 7 is arranged between the grounding electrode 39 and the fixed electrode 5, and the movable electrode is supported by a movable insulation cylinder 45 made of a ceramic through a movable connecting metallic member 44. One end of the movable insulation cylinder 45 is supported by a movable support metallic member 46, and the movable support metallic member 46 is supported by the movable blade 30. The movable blade 30 penetrates a support plate 47 and extends to the outside. The support plate 47 is fixed to the vacuum container 4. The movable blade 30 is surrounded with an expandable movable bellows 48. One end of the movable bellows 48 is attached to the support metallic member 46, and the other end is attached to the movable support plate 47. The movable blade 30 is capable of being rotated horizontally and vertically. The movable electrode 7 arranged in the top end of the movable blade 30 is rotated around a main axis 49 as the fulcrum by driving of the operating mechanism portion contained in the operation compartment 17. An operating axis 50 links between the movable blade 30 and the operating mechanism portion. The movable electrode 7 has contact points contacting with the fixed electrode 5 and the grounding electrode 39 in the both ends.

The top end of the movable electrode 7 and the load side conductor 9 are connected with a flexible conductor 22. The load side conductor 9 penetrates through a load side bushing 21 made of a ceramic material and is connected to the cable head 10. A load side seal metallic member 53 is arranged in an end portion of the load side bushing 21, and the load side seal metallic member 53 is soldered around an opening formed in the vacuum container 4 to be supported. A grounding metallic layer 54 is provided on the ceramic surface of the load side bushing 21 exposed between the outer portion of the vacuum container 4 and the cable head 10 so that leaked current flows the ground through the vacuum container 4. By taking such a safety measure, it is not dangerous even if a worker touches a portion around the cable head 10. The flexible conductor may be a bundle of conductors, a woven conductor or a laminated conductor. It is preferable to use a conductor formed by laminating thin copper plates which are easy to preventing metal-to-metal adherence in a vacuum.

In order to prevent current from flowing from the movable electrode 7 to the driving mechanism at switching on the movable electrode 7, an insulating ceramic is disposed between the movable electrode 7 and the movable blade 30. By doing so, heat generated during conducting current can be also dispersed through the ceramic having a relatively high thermal conductivity.

The grounding device 2 is formed in such a structure as follows. the grounding electrode 6 and a grounding side conductor 37 are connected to one end side of the grounding side metallic member 31. An opening grounding side bushing 32 made of a ceramic material is connected to the other end side of the grounding side metallic member 31. A flange 33 is disposed in the outer periphery of the grounding side bushing 32, and a grounding side seal metallic member 34 attached to the flange 33 is welded to the vacuum container 4. A grounding side bellows 35 and a spring 36 and the grounding side conductor 37 are disposed inside the grounding side bushing. The grounding side conductor 37 penetrates through a grounding side bottom metallic member 31 and extends to the outside, and the end portion of the grounding side bottom metallic member 31 is connected to the common grounding conductor 24 described above with a screw through a grounding conductor 38. The grounding conductor 38 is composed of a flexible conductor so as to ground to the vacuum container even when the grounding side conductor 37 is moved. The grounding electrode 39 is fixed to the grounding side conductor 37 in the opposite side. When the grounding electrode 39 is pushed by the grounding side bottom metallic member 31, the grounding side bellows 35 is compressed together with the spring 36. At that time, the grounding electrode 39 is pushed toward the movable electrode 7 by a compressed force of the spring 36.

The contact surface between the fixed electrode 5 and the grounding electrode 39 is preferably tilted in the stroke side of the movable electrode. By doing so, the gap between the fixed electrode 5 and the grounding electrode 39 can be reduced, and accordingly the vacuum container can be made smaller in size.

The fixed electrode 5 is fixed to a fixing support insulation cylinder 42 made of a ceramic material through a connecting terminal connecting metallic member 41. A fixing support metallic member for supporting another end of the fixed insulation cylinder 42 is fixed to the vacuum container with a solder material. The fixing connecting metallic member 41 and the fixing support metallic member 43 are attached to the both ends of the fixing insulation cylinder 42 in advance. A connecting terminal plate 27 is disposed in the inner surface of the vacuum container 4, and then the fixing support metallic member 43 is connected to it.

Referring to FIG. 7, the position where the movable electrode 7 is in contact with the grounding electrode 39 is the grounding position Y4, and the grounding electrode 39 is always pushed in the direction to the movable electrode by the spring 36. Referring to FIG. 8, the position where the movable electrode 7 is in contact with the fixed electrode 5 and is also connected to the load side conductor 9 is the switching-on position Y1.

In the switching-on position Y1, the movable electrode 7 is in contact with the fixed electrode 5 and is also connected to the load side conductor 9. In this case, since electric power is supplied from the movable electrode 7 to the load side conductor 9 through the fixed electrode 5 and the flexible conductor 22, the current path can be substantially shortened compared to the conventional one. As the result, the electric resistance can be reduced, and the electric power loss and the generated heat can be reduced by an amount corresponding to that amount.

On the other hand, electric power is always supplied to a load when the movable electrode is in the turning-on position Y1, and the operating time is longer than the time using the other positions. When the movable electrode 7 is in contact with the load side conductor 9, there is possibility that the movable electrode 7 and the load side conductor 9 may be melt-attached together.

In the present invention, the movable electrode 7 does not slide on the load side conductor 9, but the load side conductor 9 and the movable electrode 7 are connected to each other with the flexible conductor 22. Therefore, the movable electrode 7 and the load side conductor 9 do not melt-attached together.

The switchgear of the present invention can be used without the grounding position and the isolating position. When they are eliminated, the vacuum container and the operating mechanism portion can be made smaller in size, and accordingly the whole switchgear can be made smaller in size.

Since the movable electrode 7 and the load side conductor 9 are connected to each other with the flexible conductor 22, the movable electrode 7 can be connected to the load side conductor 9 and the cable head 10 in a shortest distance. As the result, the electric resistance can be reduced and accordingly the heat generated inside the vacuum container can be reduced by that amount. Further, since the flexible conductor 22 is used, the movable electrode 7 can be horizontally rotated although the movable electrode 7 is electrically connected to the load side conductor 9.

In the embodiment shown by FIG. 7 and FIG. 8, the insulator 42 is arranged in the direction of the stroke of the movable electrode 7. Therefore, even if the movable electrode 7 hits on the fixed contact point 5, the fixed contact point 5 can be pushed to the movable electrode 7 against the collision force.

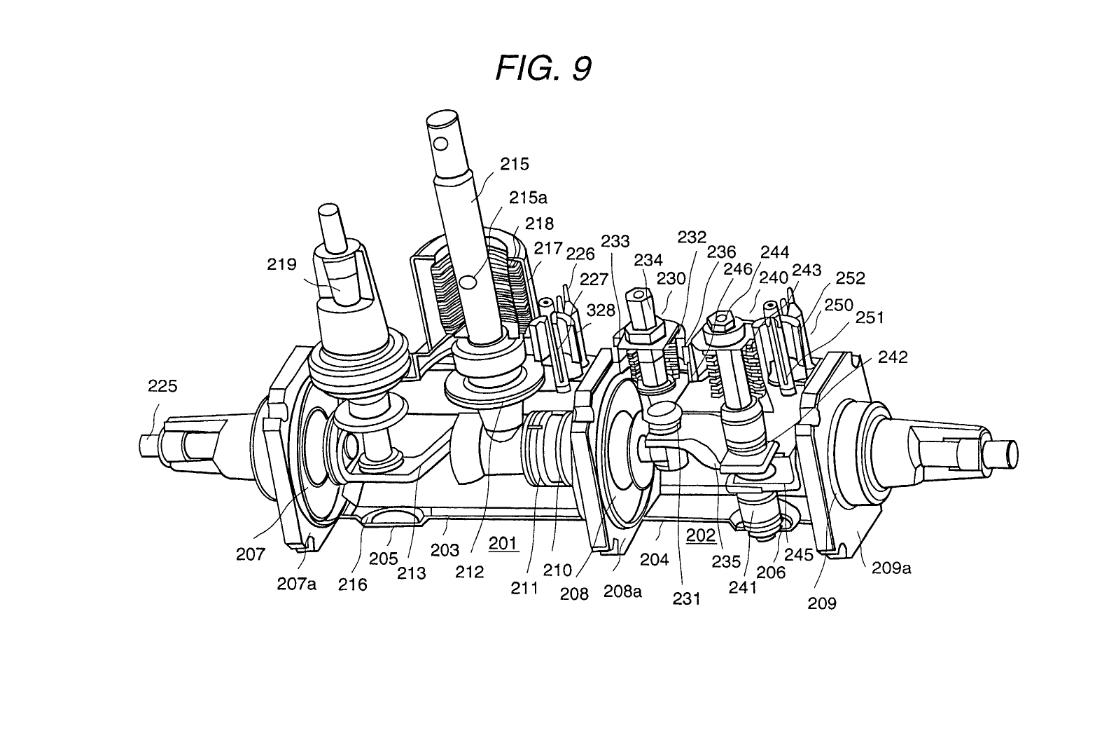

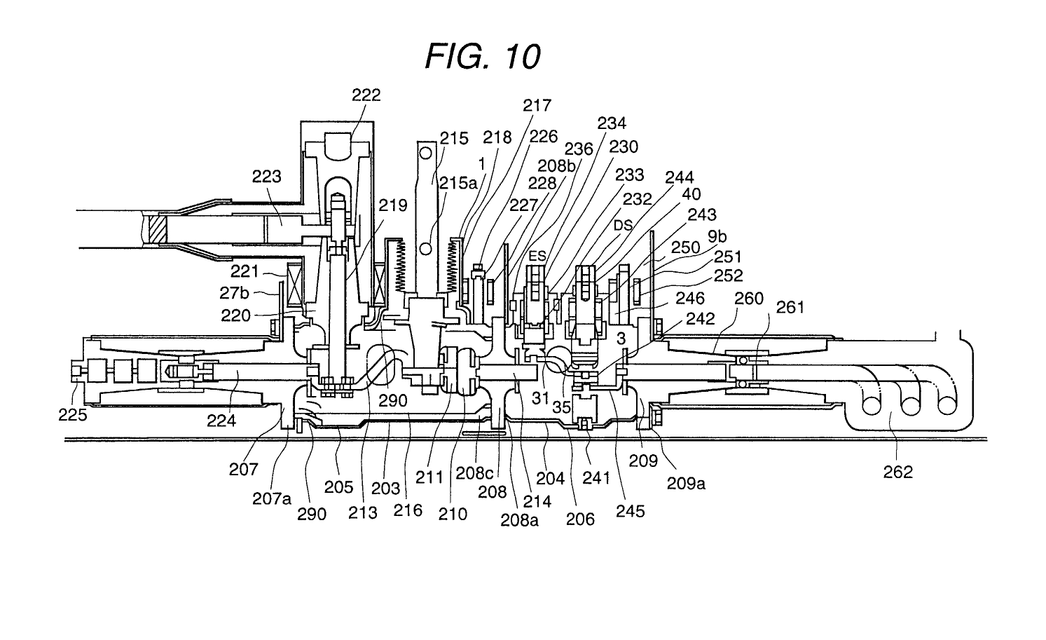

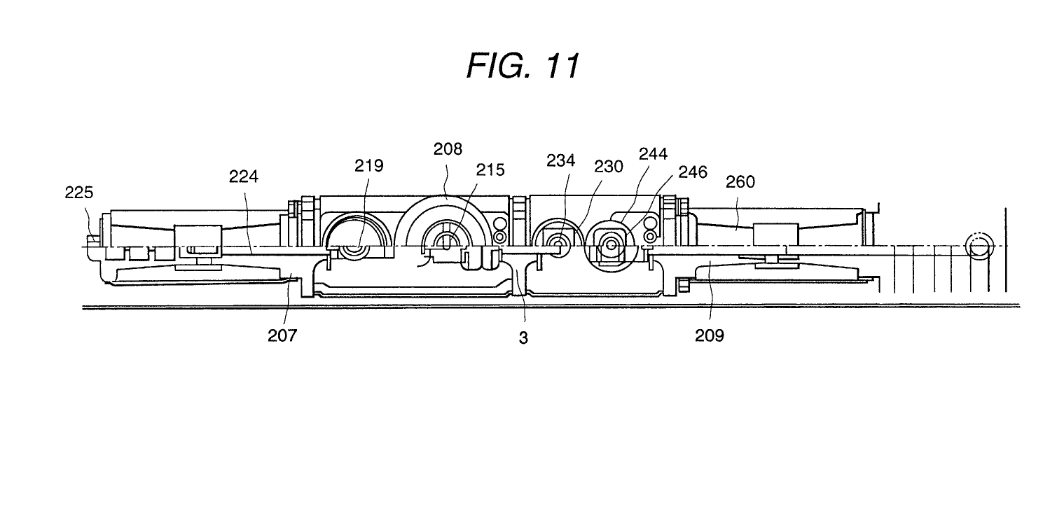

Another embodiment of the present invention is shown in FIG. 9 to FIG. 11. The vacuum switch shown in FIG. 9 to FIG. 11 comprises a vacuum container which is partitioned into two sections. FIG. 9 is a perspective view showing the present embodiment of the vacuum switch. FIG. 10 is a longitudinal sectional view showing the present embodiment of the vacuum switch. FIG. 11 is a sectional side view showing the present embodiment of the vacuum switch.

A cylindrical side wall 203 of the first vacuum container 201 is formed of an electric conductive material, for example, stainless steel, and the side wall 203 is fixed to and supported by an insulation spacer 207 portion and an insulator spacer 208 portion. A cylindrical side wall 204 of the second vacuum container 202 is formed of an electric conductive material, for example, stainless steel, and the side wall 204 is fixed to and supported by the insulation spacer 208 portion and an insulator spacer 209 portion. Metallic fixing frames 207a, 208a, 209a are arranged in the outer peripheries of the insulator spacers 207, 208, 209, and the side wall 203 is fixed by the fixing frames 207a and 208a, and the side wall 204 is fixed by the fixing frames 208a and 209a. Grounding support portions 207b, 208b, 208c and 209b are arranged in the fixing frames 207a, 208a and 209a, and the side wall 204 is grounded through an operation compartment, not shown.

A conductor 214 is arranged in the middle portion of the insulator spacer 208, and a fixed electrode 210 is arranged inside the first vacuum container 201. A movable electrode 211 is arranged opposite to the fixed electrode 210 to form a breaker. A movable blade 215 made of an insulator is connected to an operation compartment, not shown, to rotate the movable electrode 211 around a fulcrum 251a. The movable blade 215 is connected to a bellows 218.

An arc shield 216 is arranged so as to cover around the fixed electrode 210 and the movable electrode 211 and the arc shield 216 extends at a position near the insulator spacer 207. A brim portion 212 is arranged between the connection portion of the movable blade 215 and bellows 218 and the arc shield 216 to prevent an arc from going around to the back of the bellows 218 side. Further, the inner surface of the cylindrical portion 217 and an opening portion of the arc shield 216 are coated with an insulation film 290 formed by melt-spraying at least one kind selected from ceramic, aluminum oxide (Al₂O₃) and zirconium oxide (ZrO₂) to protect the inner surface from an arc leaking from the opening portion of the arc shield 216.

In the present embodiment, the film is formed through the plasma melt-spray method. The plasma melt-spray is performed by melting ceramic at a high temperature higher than 2000° C., and spraying the melted ceramic onto the inner surface of the vacuum container to form a film. As the pre-treatment, the inner surface is sandblasted to be roughened. The film thickness is set to 1.0 mm. The thickness of the film is preferably within a range of 0.1 to 2.0 mm. An ion beam irradiation method may be used for the film forming instead of the plasma melt-spray method.

The load side conductor 219 is arranged so as to extend in the same direction as the movable blade 215, and the load side conductor 219 and the movable electrode 211 are connected to each other with the flexible conductor 213. A projecting portion 205 is formed at a position opposite to the load side conductor 219, and a load side conductor is arranged using this projecting portion 205 when the load side conductor 219 needs to be grounded at the opposite side.

Since the breaker is constructed by the driving system that the movable blade 215 is rotated around the fulcrum 215a as described above, it is possible to arrange the load side conductor in one side of the first vacuum container and the second vacuum container containing the isolator and the grounding device in the other side. Thereby, the vacuum switchgear can be made small in size. In addition, since the first vacuum container containing the breaker and the second vacuum container containing the isolator and the grounding device are connected to each other with the insulator spacer, the reliability on the insulating performance can be improved. Further, since the breaker, and the isolator and the grounding device can be separately assembled, the freedom of constructing switchgears can be increased.

The load side conductor 219 is fixed to and supported by the load side bushing 220 made of a ceramic material fixed top the side wall 203. A current transformer 221 is arranged in the outer peripheral side of the load side bushing 220. A terminal 222, outside of which is fixed to and supported by an insulator made of a ceramic material, is formed on an extending line of the load side conductor 219. The load side conductor 219 is connected to the cable head 223, and the cable head 223 extends in an aligning direction of the conductor 214, the movable electrode 210 and the fixed electrode 211. A conductor 224 is arranged penetrating the central portion of the insulation spacer 207 to form a terminal 225 for measuring voltage. As described above, by attaching the terminal 225, voltage can be measured.

A vacuum gauge 226 for measuring a vacuum degree of the first vacuum container is attached to the grounded side wall 203. This vacuum gauge is a magnetron type gauge, and is attached onto the side wall 203 of a metallic container.

The grounding device 230 and the isolator 240 are arranged in the second vacuum container 202. The fixed electrode 231 of the grounding device 230 is attached to the conductor 214, and the fixed electrode 231 is electrically connected to the fixed electrode 242 of the isolator 240 through the flexible conductor 235. The fixed electrode 242 is fixed to and supported by the insulator 241 fixed to projecting portions 206 arranged in the bus side conductor 250 and the side wall 204. The movable electrode 232 is arranged opposite to the fixed electrode 231, and the movable electrode can be brought in and out of contact with the fixed electrode 231 by reciprocal movement of a rod 234 operated by an actuator, not shown. A bellows 233 is arranged between a cylinder portion 236 disposed in the side wall 204 and the movable electrode 232 to maintain gas-tightness of the second vacuum container 202. The movable electrode 242 of the isolator 240 is arranged opposite to the fixed electrode 241, and the movable electrode can be brought in and out of contact with the fixed electrode 241 by reciprocal movement of a rod 244 operated by an actuator, not shown. A bellows 243 is arranged between a cylinder portion 246 disposed in the side wall 204 and the movable electrode 242 to maintain gas-tightness of the second vacuum container 202. A vacuum gauge 250 for measuring a vacuum degree of the second vacuum container 202 is attached to the side wall 204. The vacuum gauge 250 is composed of a coaxial electrode 251 and a magnetic field generating coil or a ring-shaped magnet 252 arranged around the coaxial electrode, similarly to the vacuum gauge 226. The inner electrode of the coaxial electrode 251 is connected to a power supply circuit, and a negative direct current voltage is applied to the inner electrode by the power supply circuit. In this embodiment, since the first vacuum container 201 and the second vacuum container are provided with the vacuum gauges 226 and 250, the vacuum degrees during power supplying can be monitored. When the vacuum degree is decreased lower than 10⁻⁴ torr, an alarm is generated or a signal is transmitted to a monitoring unit because the insulation performance is reduced. Therein, the meaning that the vacuum degree is decreased lower than 10⁻⁴ torr is that the vacuum degree becomes, for example, 10⁻³ torr.

In the vacuum switch of the present embodiment, since the movable blade 215 and the rods 234, 244 are arranged in the same direction, the actuators can be arranged in the operation compartment together and accordingly the machine can be made simple and small. Further, from the viewpoint of assembling, the assembling work can be easily performed since the actuators can be assembled from the operation compartment side. Furthermore, since the measurement devices such as the vacuum gauges, the current transformer and so on are arranged in the movable blade sides, they can be assembled in the operation compartment side, and accordingly the machine can be assembled and the assembling capability can be improved.

The bus side conductor 260 is connected to a bus connection portion 262 through a connection portion 261. The bus connection portion 262 is composed of the connection portions for three phases arranged in the row direction of the first vacuum containers 201 and the second vacuum containers 202. The space inside the vacuum gauge is communicated to the vacuum container to improve the safety and reliability of the vacuum switch by measuring or always monitoring the vacuum pressure of the vacuum container. As the vacuum gauge itself, a conventional device used in a vacuum breaker or the like may be employed. The insulator spacers 207, 209 and the bushing 220 may be formed in the same shape, and accordingly commonality of the components can be made. The insulator spacer 208 may be eliminated. In that case, in order to protect the bellows 233, 244 from an arc generated by the movable electrode 211 at detaching from the fixed electrode 210, arc shields 237, 247 are arranged in the inner surfaces of the bellows 233, 234 in the inner peripheral side. The arc shields are coated with an insulation formed by melt-spraying at least one kind selected from ceramic, aluminum oxide (Al₂O₃) and zirconium oxide (ZrO₂). Operation of the switchgear constructed as described above will be described below. During power supplying, electric power supplied through the connection portion 262 is supplied to the load side through the bus side conductor 260, the conductor 245, the conductor 214, the fixed electrode 210, the movable electrode 211, the flexible conductor 213 and the bushing 220.

When a failure occurs in the bus or in the load side, a signal for breaking the breaker is output from the control unit based on a signal from a detector, not shown, to rotate the movable blade 215 by the actuator. By rotating the movable blade 215, the movable electrode 210 is moved from the ON-position to the OFF-position to break the circuit. At that time, an arc is generated between the fixed electrode 210 and the movable electrode 211. However, since the arc shield 216 is arranged in the first vacuum container 202, most part of the arc is shielded by the arc shield 216 to protect the side wall 203. Although the arc shield 216 has the opening portion in the portion where the movable blade is rotated, the opening portion is protected from the arc leaking through the opening by the insulation coating formed through melt-spray method. As the breaker is turned off, the rod 244 of the isolator 240 is moved by the actuator by a control signal from the control unit. The movable electrode 242 is detached from the fixed electrode 241, and the circuit becomes the isolating state. Then, the rod 234 of the grounding device 230 is moved, and the movable electrode 232 is brought in contact with the fixed electrode 231 to be grounded. Further, since the breaker, and the isolator and the grounding device can be separately assembled, there is an effect that the freedom of constructing switchgears can be increased. In the vacuum switch of the embodiment described above, since the movable blades and the rods are arranged in the same direction or since the measurement devices such as the vacuum gauges, the current transformer and so on are arranged in the movable blade sides, they can be assembled in the operation compartment side, and accordingly the machine can be assembled and the assembling capability can be improved.

The embodiments in accordance with the present invention are as follows.

(1) A vacuum switch characterized by that only the portion near the opening portion of the arc shield is coated with the insulation.

(2) A vacuum switch characterized by that the insulation is a ceramic.

(3) A vacuum switch characterized by that the projecting position portion is arranged in the ceramic connected to the movable electrode to prevent metallic particles and electrons from entering in the bellows side.

(4) A vacuum switch characterized by that the insulation is Al₂O₃ or ZrO₂.

(5) A vacuum switch characterized by that the bellows is covered with the shield having the insulation coating.

(6) A vacuum switch characterized by that the thickness of the coating film formed through a plasma melt-spray method is within the range of 0.1 to 2.0 mm.

(7) A vacuum switchgear characterized by that only the portion near the opening portion of the arc shield is coated with the insulation.

(8) A vacuum switchgear characterized by that the insulation is a ceramic.

(9) A vacuum switchgear characterized by that the projecting position portion is arranged in the ceramic connected to the movable electrode to prevent metallic particles and electrons from entering in the bellows side.

(10) A vacuum switch characterized by that the insulation is Al₂O₃ or ZrO₂.

(11) A vacuum switch characterized by that the bellows is covered with the shield having the insulation coating.

(12) A vacuum switch characterized by that the thickness of the coating film formed through a plasma melt-spray method is within the range of 0.1 to 2.0 mm.

According to the switch and the switchgear in accordance with the present invention, by constructing the vacuum container of the grounded metallic material having the insulation coating on the inner surface, it is possible to provide the highly reliable switchgear which can secure safety of a worker during maintenance and inspection and can reduce current flowing in the grounded container at breaking.

What is claimed is:

1. A vacuum switch comprising a pair of detachable electrodes inside a grounded vacuum container, wherein an insulation is applied onto an inner surface of said vacuum container.

2. A vacuum switch according to claim 1, wherein an arc shield is disposed around the pair of electrodes, an insulation is applied onto an inner surface of the vacuum container near an opening portion of said arc shield.

3. A vacuum switch comprising a first grounded vacuum container for containing a breaker; and a second grounded vacuum container for containing an isolator and a grounding device, said first vacuum container and said second vacuum container being electrically insulated with an insulation spacer, wherein an insulation is applied onto an inner surface of said first grounded vacuum container.

4. A vacuum switch comprising a fixed electrode and a grounding electrode inside a grounded vacuum container; and a movable electrode making and breaking with the both electrodes, said movable electrode being operated so as to position at four positions of a switching-on position Y1 of a movable contact point in contact with a fixed contact point, a switching-off position Y2 of the movable contact point out of contact with the fixed contact point, an isolating position Y3 of the movable contact point keeping insulation and a grounding position Y4 of the movable contact point in contact with the grounding electrode, or at the three positions excluding the position Y4 while said movable electrode moves between said fixed electrode and said grounding electrode, wherein
an insulation is applied onto an inner surface of said vacuum container.

5. A vacuum switch according to any one of claim 1 to claim 4, wherein said insulation is a ceramic.

6. A vacuum switchgear comprising a vacuum switch having a first grounded vacuum container for containing a breaker, and a second grounded vacuum container for containing an isolator and a grounding device, said first vacuum container and said second vacuum container being electrically insulated from each other with an insulation spacer; an operating mechanism; and a control unit for controlling said operating mechanism, wherein an insulation is applied onto an inner surface of said first grounded vacuum container.

7. A vacuum switchgear comprising a fixed electrode and a grounding electrode inside a grounded vacuum container; and a movable electrode making and breaking with the both electrodes, said movable electrode being operated so as to position at four positions of a switching-on position Y1 of a movable contact point in contact with a fixed contact point, a switching-off position Y2 of the movable contact point out of contact with the fixed contact point, an isolating position Y3 of the movable contact point keeping insulation and a grounding position Y4 of the movable contact point in contact with the grounding electrode, or at the three positions excluding the position Y4 while said movable electrode moves between said fixed electrode and said grounding electrode, wherein
an insulation is applied onto an inner surface of said vacuum container.

8. A vacuum switchgear according to any one of claim 6 and claim 7, wherein an arc shield is disposed around the pair of electrodes of the breaker, an insulation is applied onto an inner surface of the vacuum container near an opening portion of said arc shield.

9. A vacuum switchgear according to any one of claim 6 and claim 8, wherein an insulation is disposed around the grounding electrode or the grounding device.

10. A vacuum switchgear according to any one of claim 6 to claim 9, wherein said insulation is a ceramic.
